(19) United States
(12) Patent Application Publication
(10) Pub. No.: US 2011/0169760 A1
(43) Pub. Date: Jul. 14, 2011

(54) DEVICE FOR CONTROL OF ELECTRONIC APPARATUS BY MANIPULATION OF GRAPHICAL OBJECTS ON A MULTICONTACT TOUCH SCREEN

(75) Inventor: Guillaume Largillier, Bordeaux (FR)

(73) Assignee: STANTUM, Bordeaux (FR)

(21) Appl. No.: 13/062,883

(22) PCT Filed: Sep. 22, 2009
(86) PCT No.: PCT/FR09/01121

§ 371 Date: Mar. 8, 2011

(30) Foreign Application Priority Data
Sep. 22, 2008 (FR) 08/05183

(51) Int. Cl. G06F 3/041

(52) U.S. Cl. 345/173

(57) ABSTRACT

A device for controlling an electronic apparatus by handling graphic objects. The device includes a visualisation screen, a transparent multi-contact touch sensor for acquiring multi-contact touch information generated by a plurality of pointing devices, and an electronic control circuit for generating control signals based on the touch information and for generating graphic objects on the visualisation screen. Each of the graphic objects is associated with at least one specific processing rule. Each piece of touch information is subjected to a specific processing determined by the location thereof relative to the position of the graphic objects. A first series of main graphic objects and a second series of subordinate graphic objects respectively have main and subordinate complementary functions associated respectively with at least one main specific processing rule and at least one subordinate specific processing rule. All the graphic objects are arranged such that the first series is handled by a first set of pointing devices and the second series is handled by a second set of pointing devices different from the first set, the handling of at least one of the subordinate graphic objects resulting in modifications of the properties of at least one of the main graphic objects.

### TECHNICAL FIELD

The present invention relates to the field of man-machine interfaces, which concerns all devices that permit users to control electronic or information processing equipment items. It encompasses, for example, mechanical interfaces such as buttons, a keyboard or a scroll wheel. It may also encompass pointing interfaces such as a mouse, a touch pad (“trackpad” in English language), a joystick or a graphic tablet.

It relates more particularly to a device for control of an electronic equipment item by manipulation of graphical objects, this device being provided with a display screen, a transparent multicontact touch sensor for acquisition of multicontact touch information items produced by a plurality of pointing means, and an electronic control circuit capable of generating control signals according to these touch information items and of generating graphical objects on this display screen, each of these graphical objects being associated with at least one specific processing rule, each of these touch information items being the object of a specific processing determined by its location relative to the position of these graphical objects.

### PRIOR ART

Control of an electronic equipment item (mobile telephone, computer, etc.) necessitates at least one man-machine interface device so as to be able to access the diverse functionalities offered by adequate manipulation.

This manipulation is greatly facilitated and improved by coordinated use of at least two devices. In fact, certain devices are better adapted for one certain type of tasks, while others will be better adapted for a second type of task. That also allows the user to employ both hands in order to execute a larger number of tasks more rapidly.

In the case, for example, of a personal computer, two devices are at the disposal of the user: the keyboard and the mouse. Each hand is then assigned to a set of tasks: the dominant hand points with the mouse (or any other pointing peripheral)—and also performs other operations if necessary (right clicking, scroll wheel)—and the other hand executes the subordinate tasks (keyboard shortcuts, function keys). The combination of both hands makes it possible to access the set of functions of a complex software program much more rapidly and efficiently than by using the dominant hand separately.

It may also be possible to press a key with a finger of the non-dominant hand in order to display a drop-down menu at the position at which the cursor is located corresponding to the position of the mouse. The dominant hand can then select an operation in a list by displacing the cursor inside the drop-down menu by means of the mouse. Similarly, certain software programs offer advanced document-editing means that necessitate synchronous actions of both hands. For example, to copy a graphical object, a file or a block containing text, the user holds down a key of the keyboard with a finger of the non-dominant hand while simultaneously pressing the mouse button with a finger of the dominant hand. He then displaces the selected object by holding down the keyboard key and the mouse button in order to copy it.

Nevertheless, this type of interaction solution for rapid manipulation of graphical objects cannot be used with portable electronic apparatuses, and more particularly with third-generation mobile telephones, ultra-mobile computers or even portable game consoles. In fact, although increasingly advanced functionalities are being offered, the miniaturization and the space constraints of these apparatuses do not permit a plurality of man-machine interface devices to be combined.

To respond to these space constraints, an increasing number of manufacturers of portable electronic apparatuses are using a touch screen as the main man-machine interface device.

One solution for facilitating the manipulation of a portable man-machine interface device is described in Patent Document FR 2751442. This proposes a device provided with a keyboard of reduced size and a touch screen associated with the keyboard. On the one hand this keyboard is provided with a smaller number of keys compared with the number of keys of traditional keyboards, and on the other hand it makes it possible to position a cursor and to select objects on the screen. The touch screen makes it possible to use characters not provided on the keyboard and to activate contextual commands. Driver means can be actuated by keyboard keys and/or by keys of the touch screen, making it possible to display, on the touch screen, alphanumerical characters not provided on the keyboard, and at the same time to display, on the display screen, alphanumerical characters provided on the keyboard. Means for controlling the display screen can themselves also be actuated by keyboard keys and/or by keys of the touch screen, making it possible to initiate the display on the display screen of an alphanumeric character provided on the keyboard or on the touch screen.

This type of solution, combining a keyboard and a touch screen, nevertheless has the disadvantage that it does not take into account the respective domination exercised by one hand of the user over the other. In fact, the manipulation of a touch screen makes a dominant hand obvious, since little effort is required of the other hand. In the particular case of portable apparatuses (telephones, mp3 readers, GPS, etc.), this other hand merely has a function of supporting the apparatus. Such lack of contribution of both hands slows the use of the screen and prevents the user from executing complex operations (editing documents, etc.). In addition, the keyboard necessarily presents miniaturized keys, which consequently are difficult to manipulate rapidly.

In the case of portable equipment items provided with only a multicontact touch screen, which is therefore capable of being manipulated simultaneously by a plurality of pointing means, the contribution of both hands of the user is not sufficiently taken into account for improving the manipulation of graphical objects. In Patent Document US 2003/098858, the touch screen displays a virtual standard keyboard provided with a set of virtual keys. The user can use a key by pointing at it with a pointing means (finger, stylet, etc.). In Patent Document US 2006/097991, the man-machine interface at the disposal of the touch screen permits the user to move a pointing means in order to select a graphical object easily. In Patent Document FR 2866726, the touch screen comprises a screen, a transparent multicontact touch sensor for acquisition of touch information items, as well as calculating means generating control signals according to these touch information items. Graphical objects are generated on the touch screen, each of these graphical objects being associated with at least one specific processing rule. The sensor delivers a plurality of touch information items upon each acquisition. Each of these touch information items is the object of a specific processing determined by its location relative to the position of one of these graphical objects.

Nevertheless, none of these solutions is designed for working with both hands, since these interface systems are in fact not provided for managing task sharing between the two hands. Thus the hand having a function of supporting the portable multicontact touch screen has only this function, and the man-machine interface is not set up in such a way to permit it to execute subordinate tasks that would result in lightening the workload of the dominant hand and in this way facilitate the manipulation of graphical objects.

### OBJECT OF THE INVENTION

The object of the present invention is to remedy this technical problem, or in other words task sharing between the two hands, with a view to undertaking rapid and complex manipulations. For that purpose it proposes defining a first series of main graphical objects and a second series of subordinate graphical objects, associated respectively with specific processing rules and with main and subordinate functions. These two types of graphical objects are capable of interacting in complementary manner with a view to executing predetermined complex tasks. The graphical objects are organized at the display screen, in such a way that the first series of objects can be manipulated by a first set of pointing means and the second series of objects can be manipulated by a second set of pointing means.

The approach to the solution consisted in searching for solutions for making different levels of graphical objects interact according to their respective manipulation difficulties. It then became apparent that a distribution of tasks allocated to each set of pointing means according to the complementary nature of functions of the graphical objects makes it possible to combine the set of graphical objects with a plurality of pointing means—for example the fingers of two different hands of a given user.

With this objective, the object of the invention is a device for control of an electronic interface by manipulation of graphical objects. This device is provided with a display screen, a transparent multicontact touch sensor for acquisition of multicontact touch information items produced by a plurality of pointing means, and an electronic control circuit capable of generating control signals according to these touch information items and of generating graphical objects on this display screen. Each of these graphical objects is associated with at least one specific processing rule. Each of these touch information items is the object of a specific processing determined by its location relative to the position of these graphical objects. This device is characterized in that it comprises a first series of main graphical objects and a second series of subordinate graphical objects, each of these main graphical objects having a main function and being associated with at least one main specific processing rule, each of these subordinate graphical objects having a subordinate function and being associated with at least one subordinate specific processing rule. The functions of these subordinate graphical objects are complementary to the functions of these main graphical objects. These subordinate graphical objects are disposed on the display screen at locations different from those of these main graphical objects. These graphical objects are organized such that this first series is manipulated by a first set of pointing means and this second series by a second set of pointing means distinct from the first set. The manipulation of at least one of these subordinate graphical objects leads to modifications of the properties of at least one of these main graphical objects.

This combination between the division of graphical objects over their specific processing rules and their associated functions, and the organization of these graphical objects relative to the pointing means, makes it possible to manipulate an electronic apparatus equipped with a touch screen with different pointing means, without losing time or making complex and tedious manipulation efforts.

According to a particular embodiment, one of the properties of at least one of the main graphical objects modified by the manipulation of at least one of the subordinate graphical objects is the display.

According to an embodiment complementary to the foregoing, one of the properties of at least one of the main graphical objects modified by the manipulation of at least one of the subordinate graphical objects is the associated specific processing rule.

According to an embodiment also complementary to the foregoing, one of the properties of at least one of the main graphical objects modified by the manipulation of at least one of the subordinate graphical objects is the location on the display screen.

Preferably the first set of pointing means is manipulated by one hand.

In this case, according to a particular embodiment, the first set of pointing means comprises a stylet manipulated by one hand, making it possible in particular to execute functions of fine writing on the touch screen with which the electronic equipment item is provided.

According to another embodiment, the first set of pointing means comprises at least one finger of one hand.

Preferably the second set of pointing means is manipulated by one hand.

In this case, according to a particular embodiment, the second set of pointing means comprises at least one finger of one hand. In this way it is possible to benefit from this hand, for example for a function of supporting the electronic equipment item according to the need required by the application.

Advantageously, the hands of the first and second sets of pointing means are respectively two different hands of a user. In this way the manipulation of graphical objects is optimized by using the complementary nature of the two hands of the user.

In the case in which the hands of the first and second sets of pointing means respectively comprise a dominant hand and a non-dominant hand, the dominant hand preferably manipulates the main graphical objects and the non-dominant hand preferably manipulates the subordinate graphical objects. In this way the tasks to be performed by each hand are allocated to appropriate levels of complexity, thus offering more precise manipulation of the graphical objects.

According to a particular embodiment, a main function of at least one main graphical object is a writing function.

According to another particular embodiment, a main function of at least one main graphical object is a pointing function.

According to another particular embodiment, a subordinate function of at least one subordinate graphical object is a function of selection of functions allocated to at least one main graphical object manipulated by the dominant hand.

Again in the case in which the hands of the first and second sets of pointing means respectively comprise a dominant hand and a non-dominant hand, the main and subordinate graphical objects are preferably located in such a way that they are closer to the dominant hand and to the non-dominant hand respectively. In this way the distances to be traveled by the pointing means are shortened and the speed of manipulation is therefore optimized.

In the case in which the electronic equipment item is portable, the non-dominant hand advantageously provides support for the electronic equipment item, thus giving this hand a double function in addition to that of employing secondary keys.

Preferably the position of at least one subordinate graphical object is modified by the user. This operation may be executed by way of an additional graphical object or of an operation of sliding the corresponding pointing means while holding down the corresponding detection zone.

Preferably the acquisition properties are modified according to the first and second sets of pointing means and main and subordinate graphical objects. In this way it is possible, for example, to adapt the resolution and the frequency of scanning according to the needs of the graphical object under consideration. In the case, for example, of a main graphical object whose function is writing, it will be possible to undertake acquisition of very high resolution on this graphical object in order to obtain finer touch information items on what the user has written.

### BRIEF DESCRIPTION OF THE DRAWINGS

An embodiment of the invention now is described with reference to the attached figures, showing, respectively,

FIG. 1, a diagram of a device for control of an electronic equipment item incorporating a multicontact touch screen according to the invention,

FIG. 2, a structural diagram of a device comprising a multicontact touch screen according to the invention,

FIGS. 3A to 3C, diagrams illustrating different functions that can be presented by a main graphical object, and

FIGS. 4, 5A, 5B, 6, 7, 8A and 8B, diagrams illustrating examples of interaction and complementary nature between main and subordinate graphical objects.

In the aforesaid figures, identical references relate to similar technical characteristics, unless otherwise indicated.

### DETAILED DESCRIPTION OF PARTICULAR EMBODIMENTS

As illustrated in FIG. 1, the device comprises an electronic equipment item 1 such as a display unit of known type. This display unit may be, for example a liquid crystal display unit. This display unit makes it possible to display a plurality of graphical objects 2 and 3. A transparent multicontact touch sensor 4 is disposed above the display unit. It makes it possible to acquire a set of simultaneous contact points, each contact corresponding to the presence of an object 5b or of a finger 5c, 5d or 6b on the surface of sensor 4, in order to manipulate main graphical object 2 and the set of subordinate graphical objects 3a, 3b, 3c and 3d.

Among the contact means being used, a first set 5 consists of dominant hand 5a, which is holding a stylet 5b. Thumb 5c and index finger 5d may also serve as pointing means. A second set 6 consists of non-dominant hand 6a, which also serves as support for the electronic apparatus in the case in which this is portable. In this case, it is thumb 6b, the only movable digit, that executes pointing.

A first main graphical object 2 may be manipulated by dominant hand 5a, while a set of subordinate graphical objects 3a, 3b, 3c and 3d may be manipulated by non-dominant hand 6a. These graphical objects are disposed on screen 4 in such a way that thumb 6b is situated close to subordinate graphical objects 3a to 3d and such that stylet 5b manipulated by dominant hand 5a is situated close to main graphical object 2. In this way the travel distances of the pointing means are significantly shortened. In addition, subordinate graphical objects 3a to 3d are disposed side-by-side along a vertical axis to facilitate shifting of thumb 6b from one of the objects to another.

FIG. 1 shows the case in which dominant hand 5a is the user's right hand, while non-dominant hand 6a is his left hand. In the case in which the user has an opposite disposition of hands, it is possible to provide for adjustment of the screen by the user in view of positioning the graphical objects according to this new disposition, or in other words by placing subordinate graphical objects 3a to 3d at the right of the screen and main graphical object 2 at the left.

The multiplicity of subordinate graphical objects 3a to 3d as well as their small dimensions makes it possible to use them in particular as a drop-down menu, each subordinate graphical object constituting an alternative capable of influencing at least one of the displayed main graphical objects. In this way actuation of a subordinate graphical object 3a, 3b, 3c or 3d by contact may cause modification of the properties of main graphical object 2 or of another main graphical object that has not been displayed until that time, such as, for example, the display, the associated specific processing rule or the location on viewing screen 4.

This type of interaction between the main and subordinate graphical objects exploits to the optimum the capacities of the different pointing means capable of being used. In fact, thumb 6b of the non-dominant hand is not very mobile and easy to control, but it is nevertheless sufficient to execute subordinate tasks of selection in a drop-down menu—comprising subordinate graphical objects 3a to 3d—which constitute tasks that the dominant hand could also accomplish, but to the detriment of time spent on more complex tasks that its mobility and dexterity permit. Stylet 5b—or thumb 5c or index finger 5c—manipulated by dominant hand 5a is allocated exclusively to complex tasks (writing, drawing, etc.) that fully exploit its capacities.

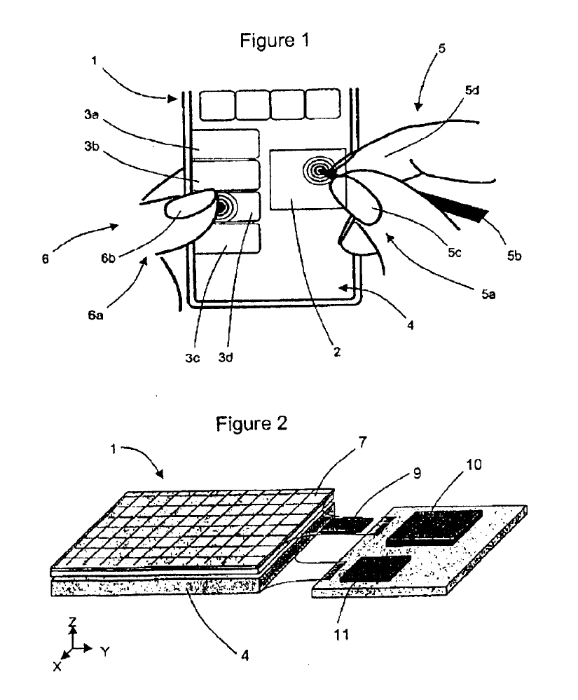

A structural diagram of the device now is described with reference to FIG. 2, which shows a cross section of this device according to one method of employment. This device comprises a transparent matrix touch sensor 7, a display screen 4, a sensing interface 9, a main processor 10 and a graphics processor 11.

The first fundamental element of this touch device is touch sensor 7, necessary for acquisition—the multicontact manipulation—by means of a sensing interface 9. This sensing interface 9 contains the acquisition and analysis circuits. Touch sensor 7 is of matrix type. It may be divided if necessary into a plurality of parts in order to accelerate sensing, each part being scanned simultaneously.

The data originating from sensing interface 9 are filtered then transmitted to main processor 10. This executes the local program that makes it possible to associate the data of the screen with graphical objects, which are allocated to screen 4 in order to be manipulated. Main processor 10 also transmits, to graphics processor 11, the data to be displayed on display screen 4. This graphics processor executes driving of the graphical interface.

Matrix sensor 1 is, for example, a sensor of resistive type or of projected capacitive type. It is composed of two transparent and superposed layers, on which there are organized rows or columns corresponding to conductive wires. In this way these layers form a matrix network of conductive wires. Thus touch sensor 7 is composed of two superposed wires, each presenting a network of transparent electrodes. These are made, for example, of indium tin oxides (ITO). The electrodes of the first layer are configured perpendicularly relative to the electrodes of the second layer in order to form a matrix. Preferably the two layers are isolated by spacing stays. The set of electrodes making up the two layers is connected to a control circuit, which makes it possible to energize and scan the touch sensor sequentially in order to deduce the state of each node of the matrix during each acquisition phase.

When it is desired to know if a contact is activated, the electrical characteristics—voltage, capacitance or inductance—are measured at the terminals of each node of the matrix. The device makes it possible to acquire the data over the entire sensor 7 with a sampling frequency on the order of 100 Hz, by employing sensor 7 and the control circuit integrated into main processor 10.

In the case of a touch sensor with passive matrix, acquisition is achieved in the following manner: the columns are energized and the response on each of the rows of the sensor is detected. Contact zones corresponding to nodes whose state is modified compared with the rest state are determined according to these responses. One or more sets of adjacent nodes whose state is modified is determined. A set of such adjacent nodes defines a contact zone. Position information referred to in the sense of this patent as a cursor is calculated from this set of nodes. In the case of a plurality of sets of nodes separated by inactive zones, a plurality of independent cursors will be determined during a given scanning phase.

This information item is refreshed periodically during new scanning phases. The cursors are created, tracked or destroyed according to the information items obtained during successive scans. By way of example, the cursor is calculated by a barycentric function of the contact zone. The general principle is to create as many cursors as there are zones of definite contact on the touch sensor and to track their evolution in time. When the user removes his fingers from the sensor, the associated cursors are destroyed. In this way it is possible simultaneously to sense the position and evolution of a plurality of fingers on the touch sensor.

Main processor 10 executes the program that makes it possible to associate the data of the sensor with graphical objects allocated to display screen 8 in order to be manipulated.

According to an advantageous embodiment, the electrical characteristic measured in each acquisition phase and at each node of the matrix is the potential. In this way it is possible to detect the action, regardless of whether it is of a finger or of a pen, for example. It is also possible to perform a measurement of the capacitance between the electrodes in parallel with or sequentially after this measurement of potential.

The control circuit may be integrated into an integrated circuit 10. This may be a microcontroller of known type. Alternatively, the integrated circuit may be an FPGA or a microprocessor. Such a microprocessor may be the main processor of electronic apparatus 1. A multiplexer may be interposed in order to limit the number of inputs and outputs on the integrated circuit.

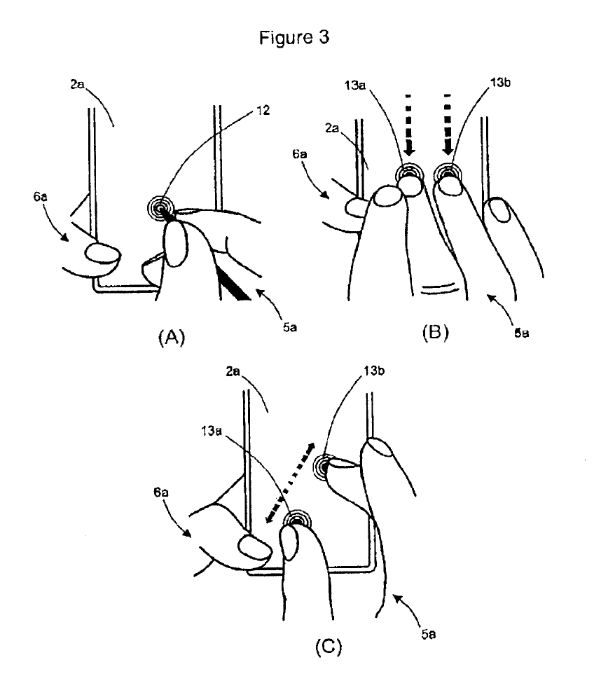

FIG. 3 shows different modes of pointing with the dominant hand on a graphical object according to one mode of employment of the invention. If a single contact point 12—a cursor—is detected above a main graphical object 2a, a first pointing method is activated (FIG. 3A). If two fingers are detected, the control circuit calculates the trajectory, the direction and the distance between the two created cursors 13a and 13b. If these cursors are displaced simultaneously in the same direction without a substantial increase of the distance between them from one frame to the other, then a second pointing mode is activated (FIG. 3B). If cursors 13a and 13b are displaced in two opposite directions or if the distance between them increases or decreases substantially from one acquisition phase to the other, then a third pointing mode is activated (FIG. 3C).

FIG. 9 shows a functional diagram of steps in which it is possible to select an appropriate control rule according to the number and displacement of each of the cursors detected above a main object.

The specific processing rule associated with the displayed graphical object will then be applied according to the pointing mode. For example, if graphical object 2a is a photograph or a drawing, the first mode will make it possible, for example, to displace graphical object 2a according to the positioning of cursor 12. The second mode will make it possible, for example, to accelerate the displacement according to the trajectory of the two cursors 13a and 13b, while the third mode will make it possible, for example, to enlarge the object according to the distance between the two cursors 13a and 13b.

The pointing modes illustrated by FIG. 3 may be applied to other types of graphical objects. For example, if the graphical object is a text zone permitting the user to acquire a manuscript by means of the fingers or of a stylet, processing rules specific to this object will be applied according to the pointing mode. For example, in the first pointing mode, the trajectory of the cursor will be tracked from one phase of acquisition to the other, and a line segment or an interpolated curve will be plotted from one point to the other. This makes it possible to restitute handwriting by applying a character recognition processing. In the second pointing mode, the user will be able to scroll the text zone. In the third pointing mode, the user spreads his fingers apart or brings them closer together in order to enlarge the text zone.

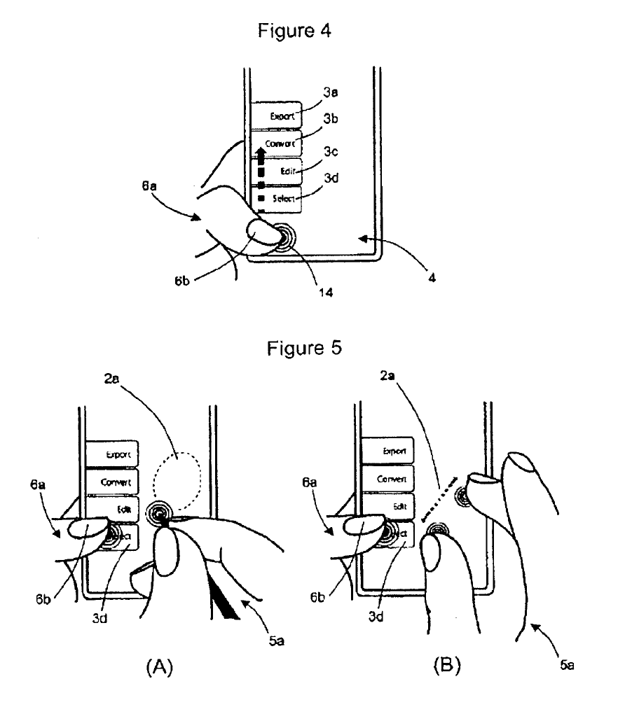

FIG. 4 shows a mode of pointing with non-dominant hand 6a. Typically, with a portable apparatus, non-dominant hand 6a supports the apparatus. Only thumb 6b is available for operation. Nevertheless, it is able to manipulate graphical objects such as buttons disposed on the edge of the screen.

The disadvantage of this type of arrangement is that it multiplies the risk that such graphical objects will be actuated accidentally. In order to minimize this risk, a priority pointing mode makes it possible to activate a first button 14 positioned at the left inside corner of screen 4, thus causing a menu comprising a defined number of buttons 3a to 3d to drop down along the screen. To access the different buttons, thumb 6b of non-dominant hand 6a slides vertically.

Advantageously, when bottom button 14 is actuated, a countdown (TTL=“Time to Live” in English language) is activated. In this way, if none of graphical objects 3a to 3d of the menu has been actuated at the end of this countdown, the drop-down menu ceases to be displayed. As an example, the TTL delay may be two seconds. This configuration offers the advantage of accessing multiple supplementary functionalities rapidly and reliably.

Advantageously, the drop-down menu proposes sub-menus disposed perpendicularly relative to the first drop-down menu.

In order to make manipulation more effective, the pointing modes described in the foregoing may be combined.

FIGS. 5A and 5B show one mode of combination of pointing modes described by FIGS. 3 and 4. In the example, cited in the foregoing, of an application that makes it possible to manipulate a photograph or any other image, the activation of a button of the drop-down menu by thumb 6b of non-dominant hand 6a modifies the specific processing rule applied to graphical object 2a being manipulated by dominant hand 5a. Thus, when “select” button 3d (“select” in English language) is selected, the first pointing mode (FIG. 5A) of dominant hand 5a has the effect of encircling a portion of the image in order to select it, while the third pointing mode (FIG. 5B) makes it possible to enlarge this selection.

In the other example, cited in the foregoing, of an application that makes it possible to acquire text in handwritten form, the activation of the same button 3d will make it possible to select the text character-by-character with the first pointing mode (FIG. 5A) and to select or deselect all of the text with the third pointing mode (FIG. 5B).

FIG. 10 shows a diagram of the steps in which it is possible to determine a collection of specific control rules by means of a subordinate object (3a to 3d) then to select an appropriate control rule among the collection of control rules according to the pointing mode.

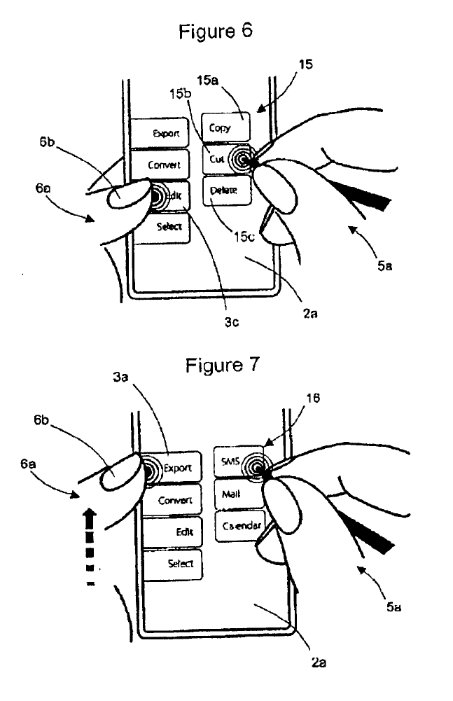

Similarly, FIGS. 6 and 7 illustrate another mode of combining pointing modes described in the foregoing. Here, instead of modifying the specific rule for processing main graphical object 2a manipulated by dominant hand 5a, the activation of a button 3c of the drop-down menu by thumb 6b of non-dominant hand 6a causes another main object superposed on first main object 2a to be displayed temporarily. This object may be, for example, a drop-down menu offering different functionalities in the form of a numbered list or of a list of icons. Dominant hand 5a may then select one of the functions. In this way, if the thumb of non-dominant hand 6a selects “edit” button 3c (“edit” in English language) as illustrated in FIG. 6, a drop-down menu 15 appears, making it possible to execute a plurality of operations with dominant hand 5a: copy 15a, paste 15b, delete 15c. If thumb 6b of non-dominant hand 6a selects “export” button 3a (“export” in English language) as illustrated in FIG. 7, a menu 16 appears, making it possible to select, for example, the format or the target to which it is desired to “export” the document.

FIG. 11 shows a diagram of the steps making it possible to display a contextual object. It is to be noted that the contextual object is displayed at an arbitrary position of the screen, for example at the center.

FIG. 12 shows a variant of the method described by FIG. 11. In this embodiment, the contextual object is displayed not at arbitrarily determined coordinates but according to the last position of the last detected pointer. This embodiment is particularly advantageous for large-dimension screens. In this way, the contextual object is displayed at the last position at which the dominant hand of the user was present, thus preventing the dominant hand from being displaced to an arbitrary position of the screen in order to use the contextual object.

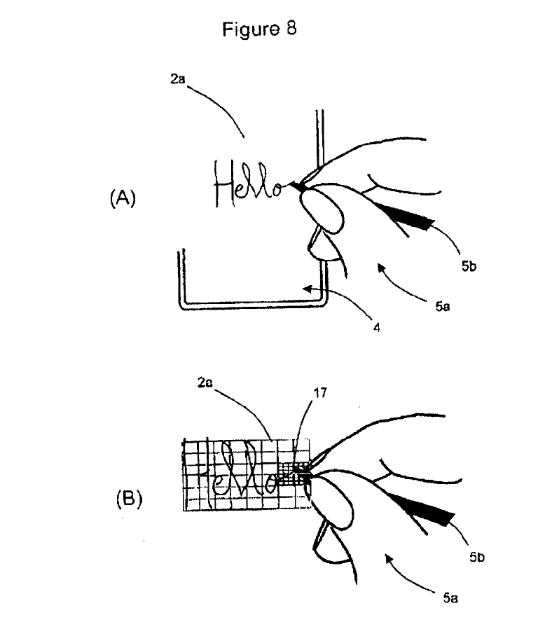

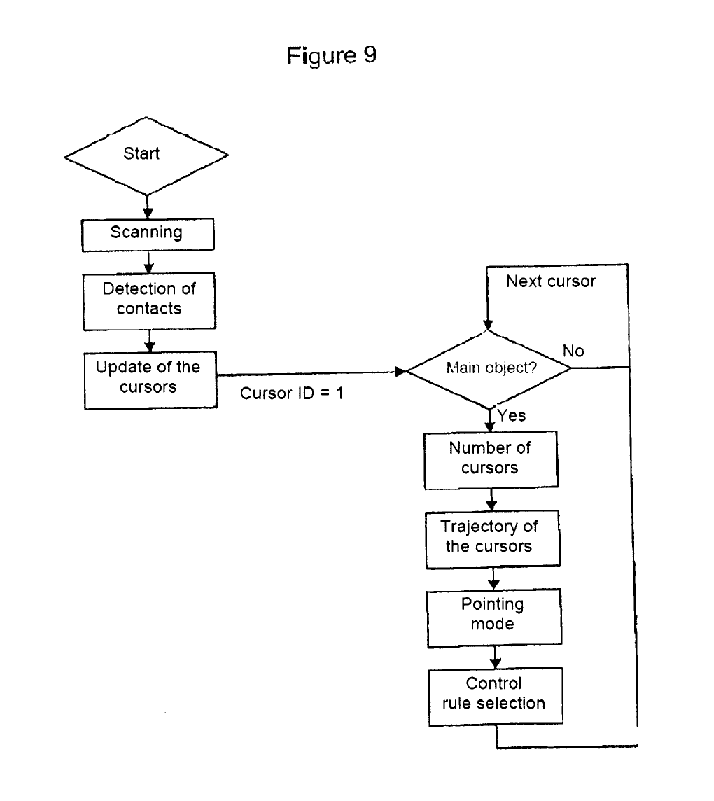

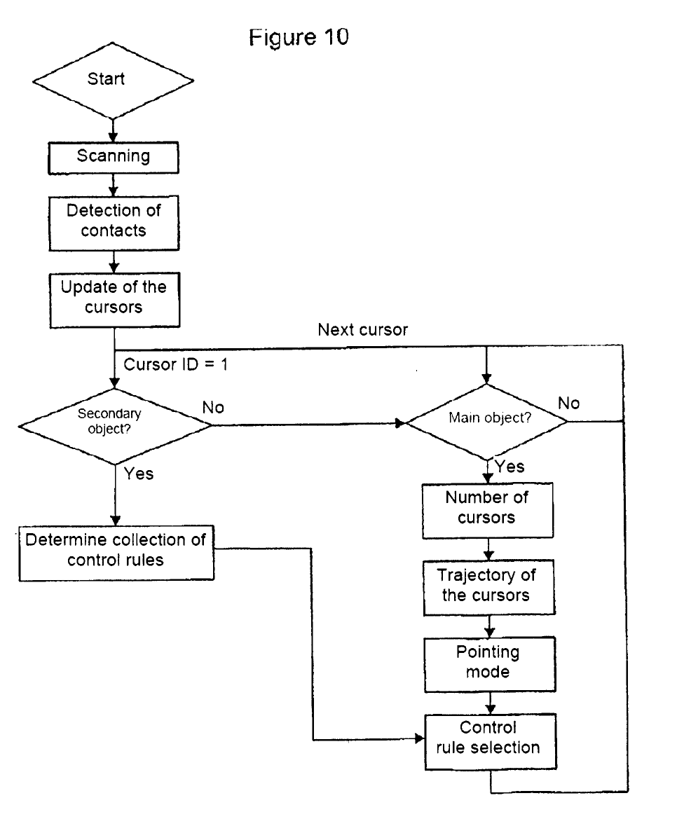

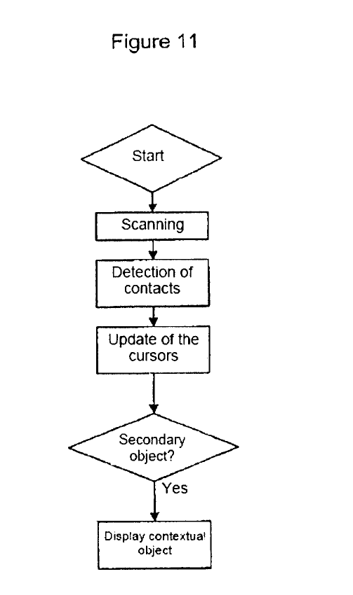

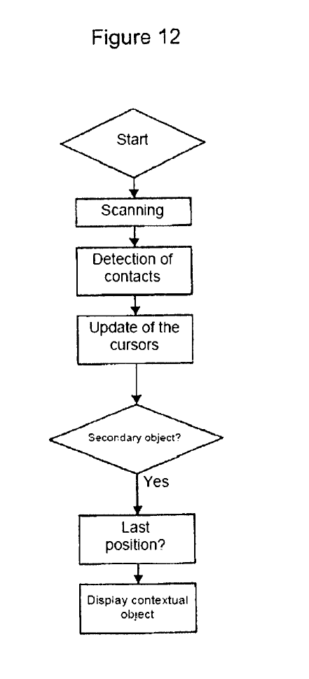

In the present case of FIG. 8, the writing function has been activated. Stylet 5b is manipulated by dominant hand 5a in order to write on graphical object 2a of display screen 4 (FIG. 8A). Advantageously, it may be provided, by the presence of a contact zone 17 (FIG. 8B), that acquisition of the matrix of the multicontact touch sensor will be achieved with greater resolution at the zone where the writing is detected. In this way the resolution is enhanced in a zone of small dimensions around the last detected contact point 17, thus making it possible to anticipate the displacement of stylet 5b during the next acquisition. Thus a commensurately more precise touch information item is obtained close to the contact zone.

The embodiments of the present invention described in the foregoing are given by way of examples and are in no way limitative. It is understood that the person skilled in the art is capable of achieving different variants of the invention without, nevertheless, departing from the scope of the patent.

1-18. (canceled)

19. A device for control of an electronic equipment item by manipulation of graphical objects, the device comprising:
a display screen;
a transparent multicontact touch sensor for acquisition of multicontact touch information items produced by a plurality of pointing means; and
an electronic control circuit configured to generate control signals according to the touch information items and to generate graphical objects on the display screen, each of the graphical objects being associated with at least one specific processing rule, each of the touch information items being an object of a specific processing determined by its location relative to the position of the graphical objects;
a first series of main graphical objects and a second series of subordinate graphical objects, each of the main graphical objects having a main function and being associated with at least one main specific processing rule, each of the subordinate graphical objects having a subordinate function and being associated with at least one subordinate specific processing rule, the functions of the subordinate graphical objects being complementary to the functions of the main graphical objects, the subordinate graphical objects being disposed on the display screen at locations different from those of the main graphical objects,
wherein the graphical objects are organized such that the first series is manipulated by a first set of pointing means and the second series by a second set of pointing means distinct from the first set of pointing means, and wherein manipulation of at least one of the subordinate graphical objects leads to modifications of properties of at least one of the main graphical objects.

20. A device according to claim 19, wherein one of the properties of at least one of the main graphical objects modified by the manipulation of at least one of the subordinate graphical objects is the display.

21. A device according to claim 19, wherein one of the properties of at least one of the main graphical objects modified by the manipulation of at least one of the subordinate graphical objects is an associated specific processing rule.

22. A device according to claim 19, wherein one of the properties of at least one of the main graphical objects modified by the manipulation of at least one of the subordinate graphical objects is a location on the display screen.

23. A device according to claim 19, wherein the first set of pointing means is manipulated by one hand.

24. A device according to claim 23, wherein the first set of pointing means comprises a stylet manipulated by one hand.

25. A device according to claim 23, wherein the first set of pointing means comprises at least one finger of one hand.

26. A device according to claim 23, wherein the second set of pointing means is manipulated by one hand.

27. A device according to claim 26, wherein the second set of pointing means comprises at least one finger of one hand.

28. A device according to claim 26, wherein the hands of the first and second sets of pointing means are respectively two different hands of a user.

29. A device according to claim 28, for which the hands of the first and second sets of pointing means respectively comprise a dominant hand and a non-dominant hand, wherein the dominant hand manipulates the main graphical objects and the non-dominant hand manipulates the subordinate graphical objects.

30. A device according to claim 29, wherein a main function of at least one main graphical object is a writing function.

31. A device according to claim 29, wherein a main function of at least one main graphical object is a pointing function.

32. A device according to claim 29, wherein a subordinate function of at least one subordinate graphical object is a function of selection of functions allocated to at least one main graphical object manipulated by the dominant hand.

33. A device according to claim 29, wherein the main and subordinate graphical objects are located such that they are closer to the dominant hand and to the non-dominant hand respectively.

34. A device according to claim 29, wherein the electronic equipment item is portable and the non-dominant hand provides support for the electronic equipment item.

35. A device according to claim 19, wherein the position of at least one subordinate graphical object is modified by the user.

36. A device according to claim 19, wherein the acquisition properties are modified according to the first and second sets of pointing means and the main and subordinate graphical objects.
